(19) United States
(12) Patent Application Publication
(10) Pub. No.: US 2016/0134610 A1
(43) Pub. Date: May 12, 2016

(54) PRIVACY DURING RE-AUTHENTICATION OF A WIRELESS STATION WITH AN AUTHENTICATION SERVER

(71) Applicant: QUALCOMM Incorporated, San Diego, CA (US)

(72) Inventors: Soo Bum Lee, San Diego, CA (US); George Cherian, San Diego, CA (US)

(21) Appl. No.: 14/926,791

(22) Filed: Oct. 29, 2015

Related U.S. Application Data
(60) Provisional application No. 62/078,162, filed on Nov. 11, 2014.

(51) Int. Cl. H04L 29/06

(52) U.S. Cl. CPC H04L 63/08; H04L 63/06

(57) ABSTRACT

Methods, systems, apparatuses, and devices are described for privacy during re-authentication of a wireless station with an authentication server. The wireless station may derive a first identifier from a re-authentication key and a sequence number. The re-authentication key may be derived at least in part from a first session key. The wireless station may transmit to an authenticator the first identifier and a domain name. The first identifier and the domain name may be transmitted during a first re-authentication of the wireless station with the authentication server. Transmission of a name of the first session key may be withheld during the first re-authentication.

### CROSS REFERENCES

The present application for patent claims priority to U.S. Provisional Patent Application No. 62/078,162 by Lee et al., titled “Privacy During Re-Authentication of a Wireless Station with an Authentication Server,” filed Nov. 11, 2014, assigned to the assignee hereof.

### BACKGROUND

1. Field of the Disclosure

The present disclosure, for example, relates to wireless communication systems, and more particularly to privacy during re-authentication of a wireless station with an authentication server.

2. Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a Wireless Local Area Network (WLAN), such as a Wi-Fi network (IEEE 802.11) may include an access point (AP) that may communicate with stations (STAs) or mobile devices. The AP may be coupled to a network, such as the Internet, and may enable a mobile device to communicate via the network (and/or communicate with other devices coupled to the access point).

Privacy for a network accessible via an AP may be managed, at least in part, by the AP and an authentication server. When a wireless station first accesses the network, the AP may initiate an authentication of the wireless station with the authentication server. When a wireless station transitions from accessing the network via a first AP to accessing the network via a second AP, the second AP may initiate a re-authentication of the wireless station with the authentication server. In either case, the wireless station may be denied access to the network if the authentication server does not authenticate (or re-authenticate) the wireless station.

### SUMMARY

The described features generally relate to various improved systems, methods, and/or apparatuses for wireless communications. Such systems, methods, and/or apparatuses may provide privacy during re-authentication of a wireless station with an authentication server (e.g., re-authentication performed as a result of station mobility and accessing a network via a different access point). When the wireless station re-authenticates with the authentication server using an Extensible Access Protocol (EAP) Re-authentication Protocol (EAP-RP), the wireless station may transmit an Extended Master Session Key name (EMSKname) to the authentication server. The EMSKname may be used to identify a re-authentication session and a corresponding re-authentication Root Key (rRK). However, the EMSKname may be transmitted over a wireless channel before a secure association is established between the wireless station and an access point (i.e., the EMSKname is transmitted without being encrypted (e.g., as plain text)). A passive attacker may therefore intercept the EMSKname and use the EMSKname to track information related to the wireless station or its user. The present disclosure describes systems, methods, and apparatus in which a wireless station may withhold transmission of the EMSKname during a re-authentication of the wireless station with the authentication server.

In a first set of illustrative examples, a method for wireless communication is provided. The method may include: deriving a first identifier at a wireless station from a re-authentication key and a sequence number, the re-authentication key derived at least in part from a first session key; transmitting to an authenticator the first identifier and a domain name, the first identifier and the domain name being transmitted during a first re-authentication of the wireless station with an authentication server; and withholding transmission of a name of the first session key during the first re-authentication.

In some aspects, the method may include generating a next sequence number based at least in part on the sequence number, and deriving a second identifier based at least in part on the re-authentication key and the next sequence number. In some aspects, the method may include transmitting the second identifier and the domain name. The second identifier and the domain name may be transmitted during a second re-authentication of the wireless station with the authentication server. In some aspects, the method may include receiving a re-authentication failure message, and transmitting the second identifier and the domain name in response to receiving the re-authentication failure message.

In some aspects, the method may include using the first identifier for a single re-authentication of the wireless station with the authentication server. In some embodiments, the method may include deriving the first identifier based at least in part on an identifier label. In some aspects of the method, the first re-authentication may include an extensible authentication protocol (EAP) re-authentication, the first session key may include an extended master session key (EMSK), and the re-authentication key may include a re-authentication root key (rRK).

In some aspects of the method, the first re-authentication may be performed after performing a full authentication with the authentication server. In some aspects, the method may include receiving a re-authentication failure message, and performing a full authentication with the authentication server in response to receiving the re-authentication failure message.

In a second set of illustrative examples, an apparatus for wireless communication is provided. The apparatus may include: a processor; memory in electronic communication with the processor; and instructions being stored in the memory. The instructions may be executable by the processor to: derive a first identifier at a wireless station from a re-authentication key and a sequence number, the re-authentication key derived at least in part from a first session key; transmit to an authenticator the first identifier and a domain name, the first identifier and the domain name being transmitted during a first re-authentication of the wireless station with an authentication server; and withhold transmission of a name of the first session key during the first re-authentication.

In some aspects, the apparatus may include instructions executable by the processor to generate a next sequence number based at least in part on the sequence number, and derive a second identifier based at least in part on the re-authentication key and the next sequence number. In some aspects, the apparatus may include instructions executable by the processor to transmit the second identifier and the domain name. The second identifier and the domain name may be transmitted during a second re-authentication of the wireless station with the authentication server. In some aspects, the apparatus may include instructions executable by the processor to receive a re-authentication failure message, and transmit, in response to receiving the re-authentication failure message, the second identifier and the domain name.

In some aspects, the apparatus may include instructions executable by the processor to use the first identifier for a single re-authentication of the wireless station with the authentication server. In some aspects, the apparatus may include instructions executable by the processor to derive the first identifier based at least in part on an identifier label. In some aspects of the apparatus, the first re-authentication may include an extensible EAP re-authentication, the first session key may include an EMSK, and the re-authentication key may include an rRK.

In some aspects of the apparatus, the first re-authentication may be performed after performing a full authentication with the authentication server. In some aspects, the apparatus may include instructions executable by the processor to receive a re-authentication failure message, and perform a full authentication with the authentication server in response to receiving the re-authentication failure message.

In a third set of illustrative examples, a method for wireless communication is provided. The method may include: deriving a first identifier, at an authentication server, from a re-authentication key and a sequence number, the re-authentication key derived at least in part from a first session key; receiving at the authentication server a second identifier, the second identifier received during a first re-authentication of a wireless station with the authentication server; comparing the first identifier to the second identifier; and transmitting a second session key to an authenticator of the wireless station based at least in part on the comparing.

In some aspects of the method, the first identifier may match the second identifier. In some aspects, the method may include generating a next sequence number based at least in part on the sequence number, and deriving a third identifier based at least in part on the re-authentication key and the next sequence number. In some aspects, the method may include receiving a fourth identifier during a second re-authentication of the wireless station with the authentication server, comparing the third identifier to the fourth identifier, and transmitting the second session key based at least in part on the comparing. In some aspects of the method, the third identifier may match the fourth identifier.

In some aspects, the method may include deriving the first identifier based at least in part on an identifier label. In some aspects, the method may include transmitting a re-authentication failure message when the first identifier fails to match the second identifier. In some aspects of the method, the re-authentication failure message may include a type-length value (TLV) element indicating a mismatch between the first identifier and the second identifier. In some aspects of the method, the first re-authentication may include an EAP re-authentication, the first session key may include an EMSK, the re-authentication key may include an rRK, and the second session key may include an rMSK.

In a fourth set of illustrative examples, an apparatus for wireless communication is provided. The apparatus may include: a processor; memory in electronic communication with the processor; and instructions being stored in the memory. The instructions may be executable by the processor to: derive a first identifier, at an authentication server, from a re-authentication key and a sequence number, the re-authentication key derived at least in part from a first session key; receive at the authentication server a second identifier, the second identifier received during a first re-authentication of a wireless station with the authentication server; compare the first identifier to the second identifier; and transmit a second session key to an authenticator of the wireless station based at least in part on the comparing.

In some aspects of the apparatus, the first identifier may match the second identifier. In some aspects, the apparatus may include instructions executable by the processor to generate a next sequence number based at least in part on the sequence number, and derive a third identifier based at least in part on the re-authentication key and the next sequence number. In some aspects, the apparatus may include instructions executable by the processor to receive a fourth identifier during a second re-authentication of the wireless station with the authentication server, compare the third identifier to the fourth identifier, and transmit the second session key based at least in part on the comparing. In some aspects of the apparatus, the third identifier may match the fourth identifier.

In some aspects, the apparatus may include instructions executable by the processor to derive the first identifier based at least in part on an identifier label. In some aspects, the apparatus may include instructions executable by the processor to transmit a re-authentication failure message when the first identifier fails to match the second identifier. In some aspects of the apparatus, the re-authentication failure message may include a TLV element indicating a mismatch between the first identifier and the second identifier. In some aspects of the apparatus, the first re-authentication may include an EAP re-authentication, the first session key may include an EMSK, the re-authentication key may include an rRK, and the second session key may include an rMSK.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communication system, in accordance with various aspects of the present disclosure;

FIG. 2 shows a key hierarchy usable for authentication or re-authentication of a wireless station with an authentication server, in accordance with various aspects of the present disclosure;

FIG. 3 shows a block diagram of an apparatus for use in wireless communication, in accordance with various aspects of the present disclosure;

FIG. 4 shows a block diagram of an apparatus for use in wireless communication, in accordance with various aspects of the present disclosure;

FIG. 5 shows a block diagram of a wireless station for use in wireless communication, in accordance with various aspects of the present disclosure;

FIG. 6 shows a block diagram of an apparatus for use in wireless communication, in accordance with various aspects of the present disclosure;

FIG. 7 shows a block diagram of an apparatus for use in wireless communication, in accordance with various aspects of the present disclosure;

FIG. 8 shows a block diagram of an authentication server for use in wireless communication, in accordance with various aspects of the present disclosure;

FIG. 9 shows a swim lane diagram illustrating aspects of wireless communication, in accordance with various aspects of the present disclosure;

FIG. 10 shows a swim lane diagram illustrating aspects of wireless communication, in accordance with various aspects of the present disclosure;

FIG. 11 shows a swim lane diagram illustrating aspects of wireless communication, in accordance with various aspects of the present disclosure;

FIG. 12 shows a flow chart illustrating an example of a method for wireless communication, in accordance with various aspects of the present disclosure;

FIG. 13 shows a flow chart illustrating an example of a method for wireless communication, in accordance with various aspects of the present disclosure;

FIG. 14 shows a flow chart illustrating an example of a method for wireless communication, in accordance with various aspects of the present disclosure; and

FIG. 15 shows a flow chart illustrating an example of a method for wireless communication, in accordance with various aspects of the present disclosure.

### DETAILED DESCRIPTION

When a wireless station (STA) re-authenticates with an authentication server (e.g., as a result of station mobility and accessing a network via a different access point), information may be transmitted from the wireless station to the authentication server before a secure association is established between the wireless station and an access point via which the wireless station communicates with the authentication server (e.g., the information may be transmitted over an unencrypted channel). The information may in some cases include an EMSKname. A passive attacker that intercepts the EMSKname may use the EMSKname to track information related to the wireless station or its user.

To mitigate an attacker's interception of useful tracking information, the methods, systems, apparatuses, and devices described in the present disclosure enable a wireless station to withhold transmission of an identifier, such as an EMSKname, during re-authentication with an authentication server. Instead of transmitting an EMSKname to identify a re-authentication session, the wireless station may transmit an identifier derived from a re-authentication key (e.g., an rRK) and a sequence number. The sequence number may be derived during, or as a result of, a mutual full authentication with the authentication server. Upon generating a first identifier for a first re-authentication session, the wireless station may increment the sequence number and derive a second identifier from the re-authentication key and a next sequence number. In this manner, each identifier of a re-authentication session is used for a single re-authentication of the wireless station with the authentication server. The identifiers used for re-authentication also enable the wireless station to withhold tracking information that may be found in an EMSKname. An authentication server that receives such an identifier may independently derive the identifier from information shared with the wireless station during a previous mutual full authentication between the wireless station and the authentication server. The authentication server may then compare the identifier derived by the wireless station and the identifier derived by the authentication server to determine whether the identifiers match. When the identifiers match, the wireless station may be re-authenticated, and the authentication server may provide a session key to an access point via which the wireless station may access a network. When the identifiers do not match, the authentication server may indicate a re-authentication failure and may, at least temporarily, instruct the access point to deny the wireless station's access to the network.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

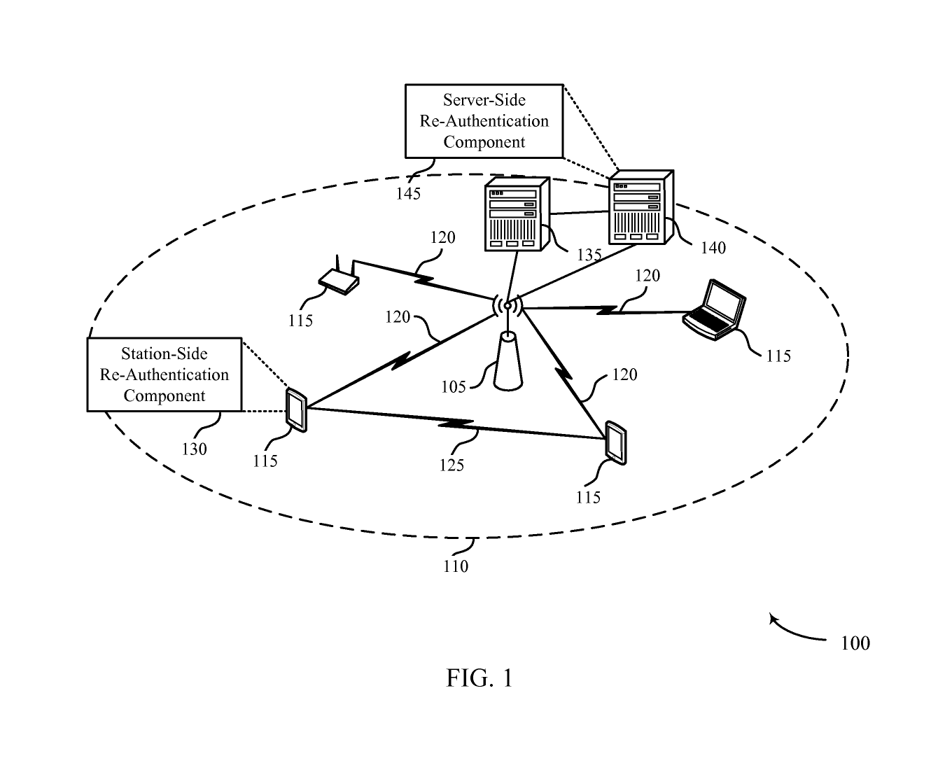

Referring first to FIG. 1, a block diagram illustrates an example of a WLAN network 100 such as, e.g., a network implementing at least one of the IEEE 802.11 family of standards. The WLAN network 100 may include an access point (AP) 105 and wireless devices or stations (STAs) 115, such as mobile stations, personal digital assistants (PDAs), other handheld devices, netbooks, notebook computers, tablet computers, laptops, display devices (e.g., TVs, computer monitors, etc.), printers, etc. While only one AP 105 is illustrated, the WLAN network 100 may have multiple APs 105. Each of the wireless stations 115, which may also be referred to as mobile stations (MSs), mobile devices, access terminals (ATs), user equipment (UE), subscriber stations (SSs), or subscriber units, may associate and communicate with an AP 105 via a communication link 120. Each AP 105 has a geographic coverage area 110 such that wireless stations 115 within that area can typically communicate with the AP 105. The wireless stations 115 may be dispersed throughout the geographic coverage area 110. Each wireless station 115 may be stationary or mobile.

Although not shown in FIG. 1, a wireless station 115 can be covered by more than one AP 105 and can therefore associate with different APs 105 at different times. A single AP 105 and an associated set of stations may be referred to as a basic service set (BSS). An extended service set (ESS) is a set of connected BSSs. A distribution system (DS) (not shown) is used to connect APs 105 in an extended service set. A geographic coverage area 110 for an access point 105 may be divided into sectors making up only a portion of the coverage area (not shown). The WLAN network 100 may include access points 105 of different types (e.g., metropolitan area, home network, etc.), with varying sizes of coverage areas and overlapping coverage areas for different technologies. Although not shown, other wireless devices can communicate with the AP 105.

While the wireless stations 115 may communicate with each other through the AP 105 using communication links 120, each wireless station 115 may also communicate directly with other wireless stations 115 via a direct wireless link 125. Two or more wireless stations 115 may communicate via a direct wireless link 125 when both wireless stations 115 are in the AP geographic coverage area 110 or when one or neither wireless station 115 is within the AP geographic coverage area 110 (not shown). Examples of direct wireless links 125 may include Wi-Fi Direct connections, connections established by using a Wi-Fi Tunneled Direct Link Setup (TDLS) link, and other P2P group connections. The wireless stations 115 in these examples may communicate according to the WLAN radio and baseband protocol including physical and MAC layers from IEEE 802.11 standard, and its various versions including, but not limited to, 802.11b, 802.11g, 802.11a, 802.11n, 802.11ac, 802.11ad, 802.11ah, etc. In other implementations, other peer-to-peer connections and/or ad hoc networks may be implemented within WLAN network 100.

Privacy for the WLAN network 100 may be managed, at least in part, by APs such as the AP 105 and an authentication server 135 or re-authentication server 140. When a wireless station 115 first accesses the WLAN network 100, the AP 105 may initiate an authentication (e.g., a full authentication) of the wireless station 115 with the authentication server 135. When a wireless station 115 transitions from accessing the WLAN network 100 via a first AP to accessing the WLAN network 100 via a second AP (e.g., the AP 105), the AP 105 may initiate a re-authentication of the wireless station 115 with the re-authentication server 140. In some examples, the authentication server 135 may include or be in communication with the re-authentication server 140, which re-authentication server 140 may execute part or all of a re-authentication protocol for the authentication server 135. For purposes of the present disclosure, the authentication server 135 and/or the re-authentication server 140 are individually and collectively referred to as an authentication server 135.

Wireless stations 115 may include a station-side re-authentication component 130 that manages aspects of privacy for wireless communications between the wireless station 115 and the WLAN network 100 (e.g., the AP 105 or authentication server 135). The authentication server 135 may include a server-side re-authentication component 145 that manages aspects of privacy for wireless communications between the wireless station 115 and the WLAN network 100 (e.g., the AP 105 or authentication server 135). In some examples, a station-side re-authentication component 130 of a wireless station 115 and the server-side re-authentication component 145 of the authentication server 135 may participate in a re-authentication of the wireless station 115 with the authentication server 135. In some examples, the re-authentication may include an Extensible Authentication Protocol (EAP) re-authentication.

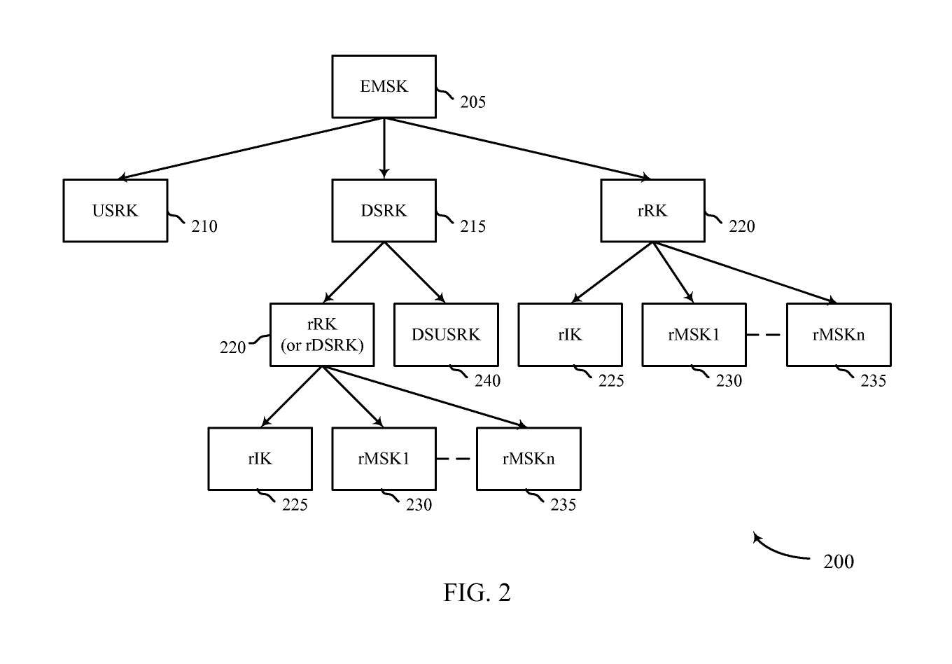

Turning to FIG. 2, there is shown an exemplary key hierarchy 200 usable for authentication or re-authentication of a wireless station with an authentication server, or for other purposes, in accordance with various aspects of the present disclosure. In some examples, the key hierarchy 200 may be an example of an EAP-RP key hierarchy usable for Wi-Fi re-authentication of a wireless station with an authentication server. In some examples, the wireless station or authentication server may be a respective example of aspects of a wireless station 115 or authentication server 135 described with respect to FIG. 1.

The root of the key hierarchy 200 includes an Extended Master Session Key (EMSK) 205. According to the Internet Engineering Task Force (IETF) Request for Comments (RFC) 3748 (RFC 3748), an EMSK may be derived as a result of a full mutual authentication between a wireless station and an authentication server and may include a length of at least 64 bytes. The EMSK 205 may be named using an EAP Session-ID and a binary or textual indication. The EAP Session-ID may be based on the EAP method being used. One exemplary EAP method is EAP-Transport Layer Security (EAP-TLS). EAP-TLS is defined in RFC 5216. According to EAP-TLS,
Key_Material=TLS-PRF-128(RK, “client EAP encryption”, client.random∥server random) (i.e., a 1024 bit output),
MSK (Master Session Key)=Key_Material(0, 63) (i.e., higher 512 bits of Key_Material),
EMSK=Key_Material(64, 127) (i.e., lower 512 bits of Key_Material), and
Session-ID=0x0D∥client.random∥server.random,
   where client.random and server.random are random numbers (32 bytes each) exchanged between an authentication server (AS) and a wireless station (STA) during a full mutual authentication, and where TLS-PRF-X produces an X byte output (i.e., 8X bits) as defined in RFC 4346. In some examples, the EMSK may be associated with an expiration time.

Keys derived from the EMSK may be referred to by an identifier of the EMSK (e.g., EMSKname) and the context of the descendant key usage, with exceptions being signaled. In some examples, EMSKname may be derived as follows:

EMSKname=KDF(EAP Session-ID,“EMSK”|“\0”|length),

where KDF is a Key Derivation Function, and where the length may be 8 bytes (64 bits). The EMSKname may be derived during, or as a result of, a full mutual EAP authentication, and may be used for conventional re-authentication processes of a wireless station, with an authentication server, until a next full mutual EAP authentication is performed between the wireless station and the authentication server.

The keys derived from the EMSK 205 may include a Usage Specific Root Key (USRK) 210, a Domain Specific Root Key (DSRK) 215, or a re-authentication Root Key (rRK) 220. An rRK 220 (or rDSRK) may also be derived from the DSRK 215. A Domain Specific Usage Specific Root Key (DSUSRK) 240 may also be derived from the DSRK 215. An rRK 220 may be derived as follows:

rRK=KDF(K,S),

where K=EMSK or K=DSRK, where S=rRK Label|“\0”|length, and where the rRK Label may be an Internet Assigned Numbers Authority (IANA)-assigned 8 bit American Standard Code for Information Exchange (ASCII) string: EAP Re-authentication Root Key@ietf.org.

A re-authentication Integrity Key (rIK) 225 and re-authentication Master Session Keys (e.g., rMSK1 230 . . . rMSKn 235) may be derived from the rRK 220 (or rDSRK). The rIK 225 may be derived as follows:

rIK=KDF(K,S),

where K=rRK, where S=rIK Label|“\0”| cryptosuite| length, and where rIK Label may be the 8 bit ASCII string: Re-authentication Integrity Key@ietf.org.

An rMSK may be derived as follows:

rMSK=KDF(K,S),

where K=rRK, where S=rMSK Label|“\0”|SEQ|length, where rMSK Label may be the 8 bit ASCII string: Re-authentication Master Session Key@ietf.org, and where SEQ may be a sequence number sent by a wireless station in an EAP-initiate/re-authentication-start (or EAP-request/identity) message and may be used for replay protection. The SEQ may be increased by 1 when re-authentication is performed and may be initialized to 0 when a new rRK is derived.

In any of the above derivations, HMAC-SHA-256 may be used as a default KDF.

When a wireless station transitions from communicating via a first access point in a network (e.g., a first access point in a WLAN network) to communicating via a second access point in the network (e.g., as a result of station mobility), the wireless station may re-authenticate itself with an authentication server. The wireless station may transition from communicating via a first access point to communicating via a second access point as a result of a handover of the wireless station from the first access point to the second access point, or for other reasons. When the wireless station re-authenticates with the authentication server using an EAP-RP, the wireless station may transmit its EMSKname to the authentication server. The EMSKname may be used to identify a re-authentication session and a corresponding rRK 220. However, the EMSKname is transmitted over a wireless channel before a secure association is established between the wireless station and an access point (i.e., the EMSKname is transmitted without being encrypted (e.g., as plain text)). A passive attacker may therefore intercept the EMSKname and use the EMSKname to track information related to a wireless station or its user. The present disclosure describes systems, methods, and apparatus in which a wireless station may withhold transmission of the EMSKname during a re-authentication of the wireless station with an authentication server.

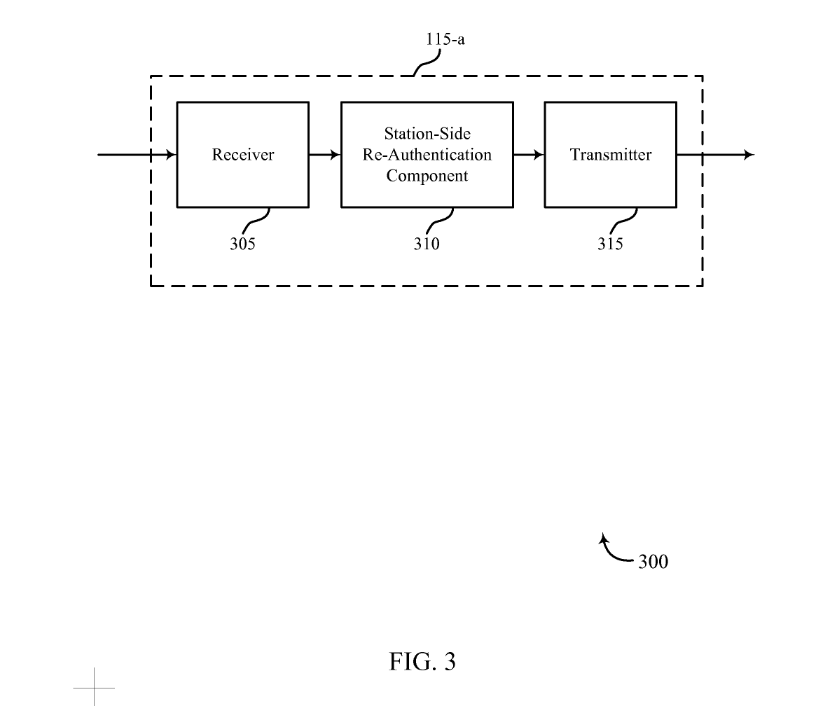

FIG. 3 shows a block diagram 300 of an apparatus 115-a for use in a wireless station for wireless communication, in accordance with various aspects of the present disclosure. In some examples, the apparatus 115-a may be an example of aspects of a wireless stations 115 described with reference to FIG. 1. The apparatus 115-a may also be or include a processor (not shown). The apparatus 115-a may include a receiver 305, a station-side re-authentication component 310, and/or a transmitter 315. Each of these components may be in communication with each other.

The apparatus 115-a, through the receiver 305, the station-side re-authentication component 310, and/or the transmitter 315, may perform functions described herein. For example, the apparatus 115-a may manage aspects of re-authenticating a wireless station including the apparatus 115-a with an authentication server.

The components of the apparatus 115-a may, individually or collectively, be implemented using application-specific integrated circuits (ASICs) adapted to perform some or all of the applicable functions in hardware. Alternatively, the functions may be performed by other processing units (or cores), on integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each component may also be implemented, in whole or in part, with instructions embodied in a memory, which instructions may be formatted to be executed by general or application-specific processors.

The receiver 305 may receive information such as packets, user data, and/or control information associated with various information channels (e.g., control channels, data channels, etc.). The receiver 305 may receive signals, messages, and the like from an access point during a re-authentication of a wireless station including the apparatus 115-a with an authentication server. Information may be passed on to the station-side re-authentication component 310, and to other components of the apparatus 115-a.

The station-side re-authentication component 310 may monitor, manage, or otherwise perform functions relating to aspects of re-authenticating a wireless station including the apparatus 115-a with an authentication server. The station-side re-authentication component 310 may derive a first identifier from a re-authentication key and a sequence number (and in some cases, from an identifier label). The re-authentication key may be derived at least in part from a first session key. The first session key may be derived during, or as a result of, a mutual full authentication between a wireless station including the apparatus 115-a and an authentication server.

The station-side re-authentication component 310 may also transmit to an authenticator (e.g., an access point) the first identifier and a domain name. The first identifier and the domain name may be transmitted during a first re-authentication of the wireless station with an authentication server, and may be transmitted via the transmitter 315. Transmission of a name of the first session key may be withheld during the first re-authentication. In some examples, the first identifier may be used for a single re-authentication of a wireless station including the apparatus 115-a with an authentication server.

In some embodiments, a re-authentication (e.g., the first re-authentication) performed by the station-side re-authentication component 310 may include a Wi-Fi re-authentication. In these embodiments, the re-authentication may include an EAP re-authentication, the first session key may include an EMSK, and the re-authentication key may include an rRK.

The transmitter 315 may transmit the signals received from other components of the apparatus 115-a. The transmitter 315 may transmit various signals, messages, etc., associated with re-authenticating a wireless station including the apparatus 115-a with an authentication server. In some examples, the transmitter 315 may be collocated with the receiver 305 in a transceiver component. The transmitter 315 may include a single antenna or a plurality of antennas.

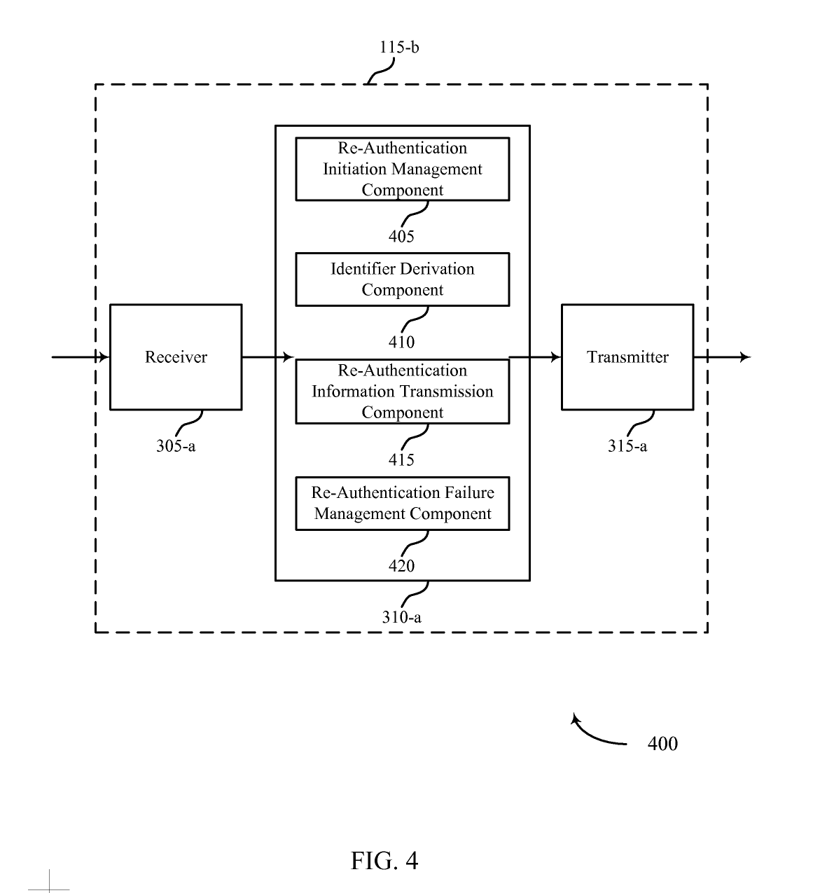

FIG. 4 shows a block diagram 400 of an apparatus 115-b for use in a wireless station for wireless communication, in accordance with various aspects of the present disclosure. The apparatus 115-b may be an example of aspects of a wireless station 115 described with reference to FIG. 1. It may also be an example of an apparatus 115-a described with reference to FIG. 3. The apparatus 115-b may include a receiver 305-a, a station-side re-authentication component 310-a, and/or a transmitter 315-a, which may be examples of the corresponding components of apparatus 115-a. The apparatus 115-b may also include a processor (not shown). Each of these components may be in communication with each other. The station-side re-authentication component 310-a may include a re-authentication initiation management component 405, an identifier derivation component 410, a re-authentication information transmission component 415, or a re-authentication failure management component 420. The receiver 305-a and the transmitter 315-a may perform the functions of the receiver 305 and the transmitter 315 of FIG. 3, respectively.

The re-authentication initiation management component 405 may monitor, manage, or otherwise perform functions related to initiation of an EAP re-authentication. The EAP re-authentication may include a re-authentication of a wireless station including the apparatus 115-b with an authentication server. In some aspects, the re-authentication initiation management component 405 may receive an EAP-initiate/re-authentication-start (or EAP-request/identity) message from an access point to which a wireless station including the apparatus 115-b has been handed over (or from an access point via which the wireless station including the apparatus 115-b is attempting to access a network).

In some aspects, the identifier derivation component 410 may manage aspects of deriving an identifier usable for re-authentication. In some examples, the identifier derivation component 410 may derive an identifier (e.g., rRKname) from a re-authentication key (e.g., an rRK), a sequence number (SEQ), and an identifier label. For example, the identifier may be derived using the formula

rRKname=KDF(rRK,rRKname Label|“\0”|SEQ|length)

where rRKname Label=“keyName”, where SEQ is a sequence number such as the sequence number defined in rMSK derivation for replay protection, and where length=8 bytes (i.e., 8 octets). The rRK may be derived at least in part from a first session key (e.g., EMSK). The first session key may be derived during, or as a result of, a mutual full authentication between a wireless station including the apparatus 115-b and an authentication server. A first identifier may be derived using the KDF for rRKname and a first sequence number (e.g., SEQ=SEQ1); a second identifier may be derived using the KDF for rRKname and a second sequence number (e.g., SEQ2=SEQ1+1); etc.

The re-authentication information transmission component 415 may manage or otherwise perform functions related to transmitting an identifier and a domain name to an authenticator (e.g., an access point) during a re-authentication of a wireless station including the apparatus 115-b with an authentication server. For example, the re-authentication information transmission component 415 may transmit a first identifier and a domain name to the authenticator during a first re-authentication of the wireless station with the authentication server, and may transmit a second identifier and the domain name to the authenticator during a further attempt to complete the first re-authentication (or during a second re-authentication of the wireless station with the authentication server). Transmission of a name of the first session key may be withheld during the further attempt to complete the first-authentication and/or during the second re-authentication. Each identifier derived by the identifier derivation component 410 may be transmitted by the re-authentication information transmission component 415 once (e.g., used during a single attempt to re-authenticate a wireless station including the apparatus 115-b with an authentication server).

The re-authentication failure management component 420, alone or in cooperation with other components of the apparatus 115-b, may manage re-authentication failures. For example, in response to receiving a re-authentication failure message, the re-authentication failure management component 420 may cause the re-authentication information transmission component 415 to transmit an identifier based on a next sequence number (e.g., the sequence number incremented by one). Alternatively, the re-authentication failure management component 420 may indicate a failure to re-authenticate with an authentication server and/or trigger a mutual full authentication with the authentication server.

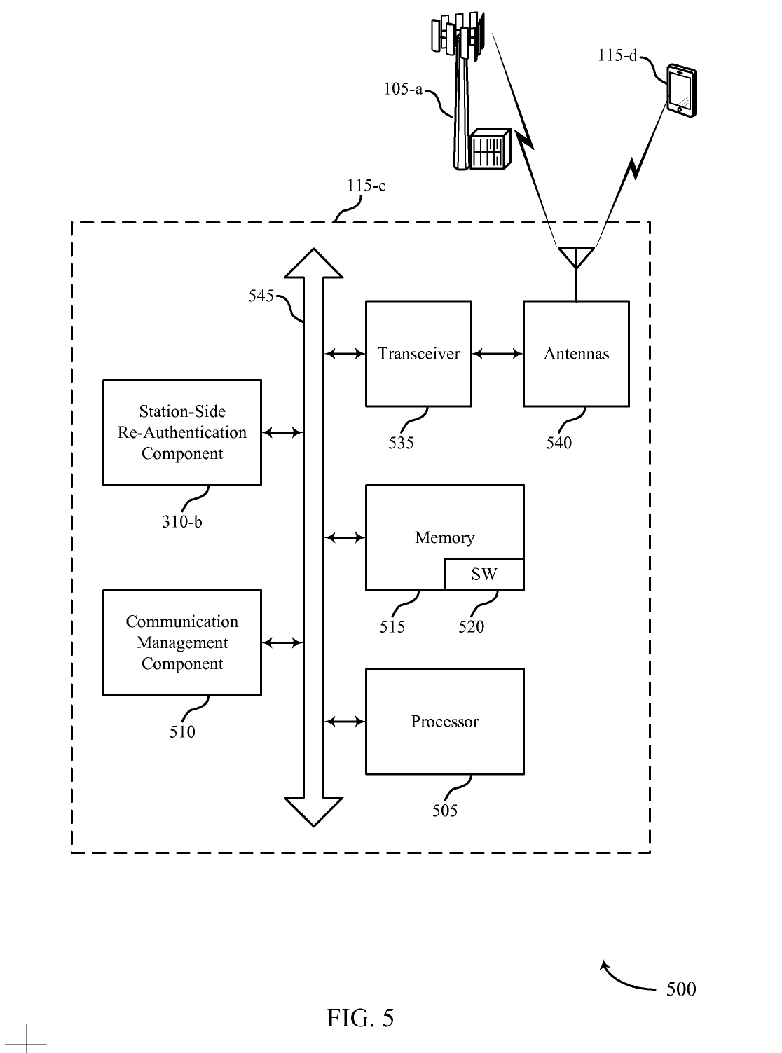

Turning to FIG. 5, a diagram 500 is shown that illustrates a wireless station 115-c capable of performing a re-authentication with an authentication server. The wireless station 115-c may have various configurations and may be included or be part of a personal computer (e.g., laptop computer, netbook computer, tablet computer, etc.), a cellular telephone, a PDA, a digital video recorder (DVR), an internet appliance, a gaming console, an e-reader, etc. The wireless station 115-c may have an internal power supply (not shown), such as a small battery, to facilitate mobile operation. The wireless station 115-c may be an example of the wireless stations 115 and/or apparatuses 115 of FIGS. 1, 3, and 4.

The wireless station 115-c may include a processor 505, a memory 515, a transceiver 535, antennas 540, a station-side re-authentication component 310-b, and a communication management component 510. The station-side re-authentication component 310-b may be an example of the station-side re-authentication component 310 of FIG. 3 or 4. Each of these components may be in communication with each other, directly or indirectly, over at least one bus 545.

The memory 515 may include random access memory (RAM) or read-only memory (ROM). The memory 515 may store computer-readable, computer-executable software (SW) code 520 containing instructions that, when executed, cause the processor 505 to perform various functions described herein for re-authenticating the wireless station 115-c with an authentication server. Alternatively, the software code 520 may not be directly executable by the processor 505 but cause the computer (e.g., when compiled and executed) to perform functions described herein.

The processor 505 may include an intelligent hardware device, e.g., a central processing unit (CPU), a microcontroller, an ASIC, etc. The processor 505 may process information received through the transceiver 535 and/or to be sent to the transceiver 535 for transmission through the antennas 540. The processor 505 may handle, alone or in connection with the station-side re-authentication component 310-b, various aspects of re-authenticating the wireless station 115-c with an authentication server.

The transceiver 535 may communicate bi-directionally with at least one AP 105 shown in FIG. 1, or with other wireless stations 115, mobile devices, and/or apparatuses shown in FIGS. 1, 3, and 4. The transceiver 535 may, in some examples, be implemented as at least one transmitter component and at least one separate receiver component. The transceiver 535 may include a modem to modulate the packets and provide the modulated packets to the antennas 540 for transmission, and to demodulate packets received from the antennas 540. While the wireless station 115-c may include a single antenna, there may be aspects in which the wireless station 115-c may include multiple antennas 540.

According to the architecture of FIG. 5, the wireless station 115-c may further include a communication management component 510. The communication management component 510 may manage communications with various access points 105-a, wireless stations 115-d, etc. The communication management component 510 may be a component of the wireless station 115-c in communication with some or all of the other components of the wireless station 115-c over the at least one bus 545. Alternatively, functionality of the communication management component 510 may be implemented as a component of the transceiver 535, as a computer program product, and/or as at least one controller element of the processor 505.

The components of the wireless station 115-c may implement aspects discussed above with respect to FIGS. 1, 3, and 4, and those aspects may not be repeated here for the sake of brevity.

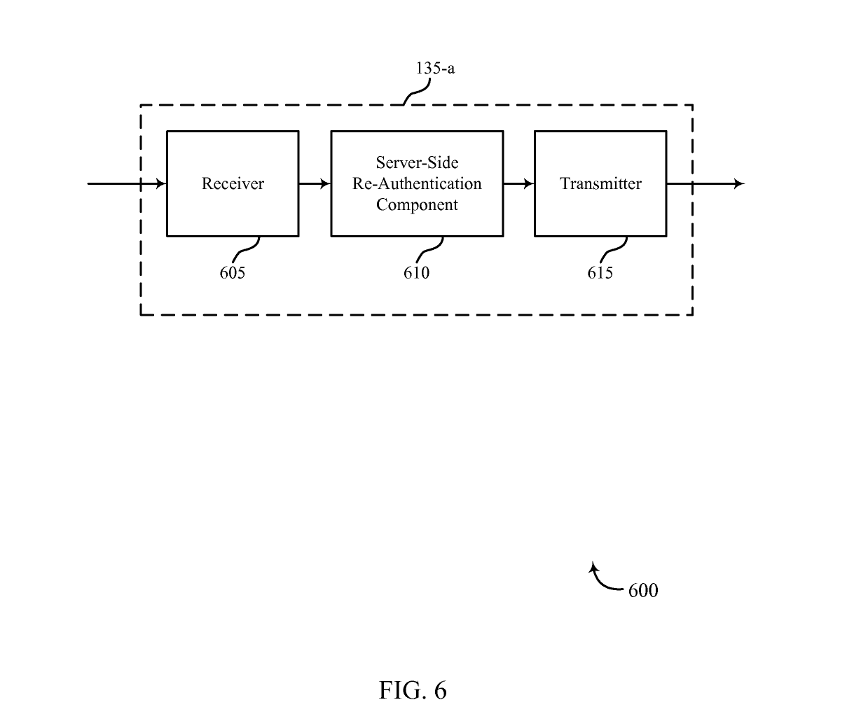

FIG. 6 shows a block diagram 600 of an apparatus 135-a for use in an authentication server, in accordance with various aspects of the present disclosure. In some examples, the apparatus 135-a may be an example of aspects of an authentication server 135 described with reference to FIG. 1. The apparatus 135-a may also be or include a processor (not shown). The apparatus 135-a may include a receiver 605, a server-side re-authentication component 610, and/or a transmitter 615. Each of these components may be in communication with each other.

The apparatus 135-a, through the receiver 605, the server-side re-authentication component 610, and/or the transmitter 615, may perform functions described herein. For example, the apparatus 135-a may manage aspects of re-authenticating a wireless station with an authentication server including the apparatus 135-a.

The components of the apparatus 135-a may, individually or collectively, be implemented using ASICs adapted to perform some or all of the applicable functions in hardware. Alternatively, the functions may be performed by other processing units (or cores), on integrated circuits. In other examples, other types of integrated circuits may be used (e.g., Structured/Platform ASICs, FPGAs, and other Semi-Custom ICs), which may be programmed in any manner known in the art. The functions of each component may also be implemented, in whole or in part, with instructions embodied in a memory, which instructions may be formatted to be executed by general or application-specific processors.

The receiver 605 may receive information such as packets, user data, and/or control information associated with various information channels (e.g., control channels, data channels, etc.). The receiver 605 may receive signals, messages, and the like from an access point during a re-authentication of a wireless station with an authentication server including the apparatus 135-a. Information may be passed on to the server-side re-authentication component 610, and to other components of the apparatus 135-a.

The server-side re-authentication component 610 may monitor, manage, or otherwise perform functions relating to aspects of re-authenticating a wireless station including the apparatus 115-a with an authentication server. The server-side re-authentication component 610 may derive a first identifier from a re-authentication key and a sequence number (and in some cases, from an identifier label). The re-authentication key may be derived at least in part from a first session key. The first session key may be derived during, or as a result of, a mutual full authentication between a wireless station and an authentication server including the apparatus 135-a.

The server-side re-authentication component 610 may also receive a second identifier. The second identifier may be received during a first re-authentication of the wireless station with an authentication server including the apparatus 135-a. In some examples, the second identifier may be used for a single re-authentication of a wireless station with an authentication server including the apparatus 135-a. In some examples, the second identifier may be received at the authentication server via an authenticator (e.g., an access point).

Still further, the server-side re-authentication component 610 may compare the first identifier to the second identifier. The server-side re-authentication component 610 may then transmit a second session key based at least in part on the comparing. For example, when the first identifier matches the second identifier, the server-side re-authentication component 610 may transmit the second session key to an authenticator (e.g., an access point) via which the second identifier is received from the wireless station.

In some embodiments, a re-authentication (e.g., the first re-authentication) performed by the server-side re-authentication component 610 may include a Wi-Fi re-authentication. In these embodiments, the re-authentication may include an EAP re-authentication, the first session key may include an EMSK, the re-authentication key may include an rRK, and the second session key may include an rMSK.

The transmitter 615 may transmit the signals received from other components of the apparatus 135-a. The transmitter 615 may transmit various signals, messages, etc., associated with re-authenticating a wireless station with an authentication server including the apparatus 135-a. In some examples, the transmitter 615 may be collocated with the receiver 605 in a transceiver component. The transmitter 615 may include a single antenna or a plurality of antennas.

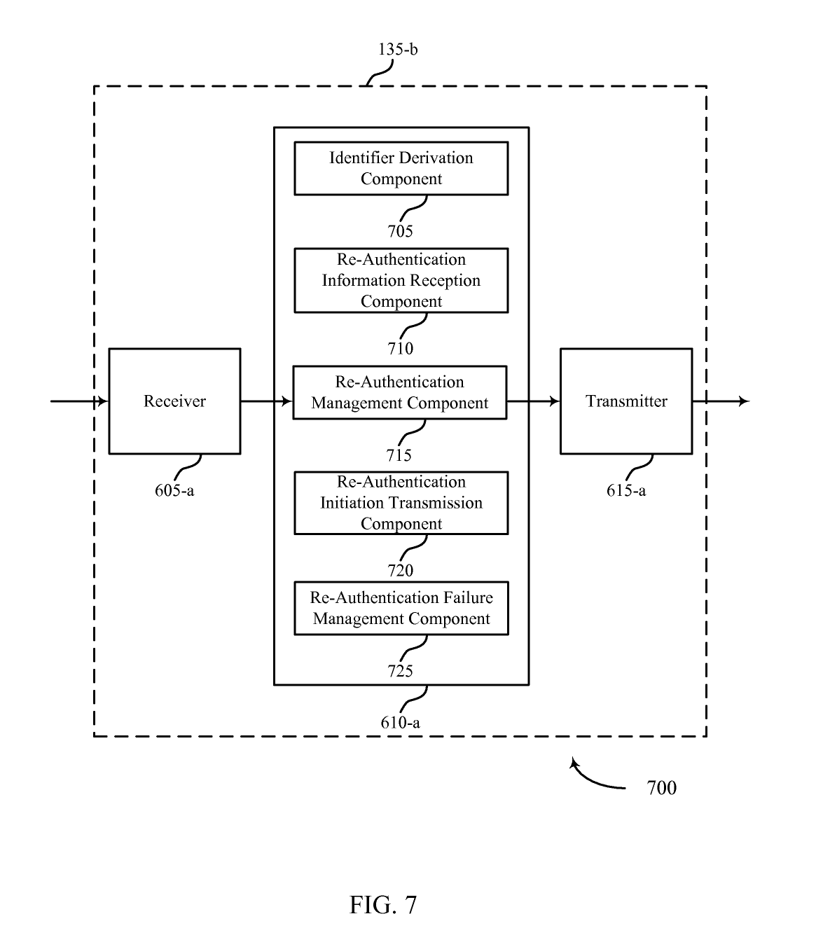

FIG. 7 shows a block diagram 700 of an apparatus 135-b for use in an authentication server for wireless communication, in accordance with various aspects of the present disclosure. The apparatus 135-b may be an example of an authentication server 135 described with reference to FIG. 1. It may also be an example of an apparatus 135-a described with reference to FIG. 6. The apparatus 135-b may include a receiver 605-a, a server-side re-authentication component 610-a, and/or a transmitter 615-a, which may be examples of the corresponding components of apparatus 135-a. The apparatus 135-b may also include a processor (not shown). Each of these components may be in communication with each other. The server-side re-authentication component 610-a may include an identifier derivation component 705, a re-authentication information reception component 710, a re-authentication management component 715, a re-authentication information transmission component 720, or a re-authentication failure management component 725. The receiver 605-a and the transmitter 615-a may perform the functions of the receiver 605 and the transmitter 615 of FIG. 6, respectively.

In some aspects, the identifier derivation component 705 may manage aspects of deriving an identifier usable for re-authentication. In some examples, the identifier derivation component 705 may derive an identifier (e.g., rRKname) from a re-authentication key (e.g., an rRK), a sequence number (SEQ), and an identifier label. For example, the identifier may be derived using the formula for rRKname, described with respect to FIG. 4. The re-authentication key (rRK) may be derived at least in part from a first session key (e.g., EMSK). The first session key may be derived during, or as a result of, a mutual full authentication between a wireless station and an authentication server including the apparatus 115-b. A first identifier may be derived using the KDF for rRKname and a first sequence number (e.g., SEQ=SEQ1); a second identifier may be derived using the KDF for rRKname and a second sequence number (e.g., SEQ2=SEQ1+1); etc.

The re-authentication information reception component 710 may manage or otherwise perform functions related to receiving an identifier during a re-authentication of the wireless station with an authentication server including the apparatus 135-b. For example, the re-authentication information reception component 710 may receive a first identifier from the wireless station during a first re-authentication of the wireless station with the authentication server, and may receive a second identifier from the wireless station during a further attempt to complete the first re-authentication (or during a second re-authentication of the wireless station with the authentication server). The identifier(s) may be received from the wireless station via an authenticator (e.g., an access point).

In some aspects, the re-authentication management component 715 may manage or otherwise perform functions related to re-authenticating a wireless station. For example, the re-authentication management component 715 may compare an identifier received from a wireless station to an identifier derived by the apparatus 135-b. The wireless station and the apparatus 135-b may synchronize their generation of sequence numbers, in addition to exchanging key information, during, or as a result of, a mutual full authentication between the wireless station and an authentication server including the apparatus 135-b. When the identifier received from the wireless station matches the identifier derived by the apparatus 135-b, the re-authentication management component 715 may cause the re-authentication information transmission component 720 to transmit a second session key. The second session key may be transmitted to an authenticator (e.g., an access point) via which the identifier received from the wireless station is received.

The re-authentication failure management component 725, alone or in cooperation with other components of the apparatus 135-b, may manage re-authentication failures. For example, when an identifier received from a wireless station fails to match the identifier derived by the apparatus 135-b, the re-authentication failure management component 725 may transmit a re-authentication failure message (e.g., as defined by RFC 6696). The re-authentication failure message may include a type-length value (TLV) element indicating a mismatch between the identifiers. The re-authentication failure message may be transmitted to the wireless station from which the non-matching identifier is received. The re-authentication failure message may be transmitted to the wireless station via an access point through which the non-matching identifier is received by the apparatus 135-b. Because the apparatus 135-b cannot match identifiers, the transmission of the re-authentication failure message may not be integrity protected (e.g., the apparatus 135-b may be unable to locate an rIK corresponding to an rRK).

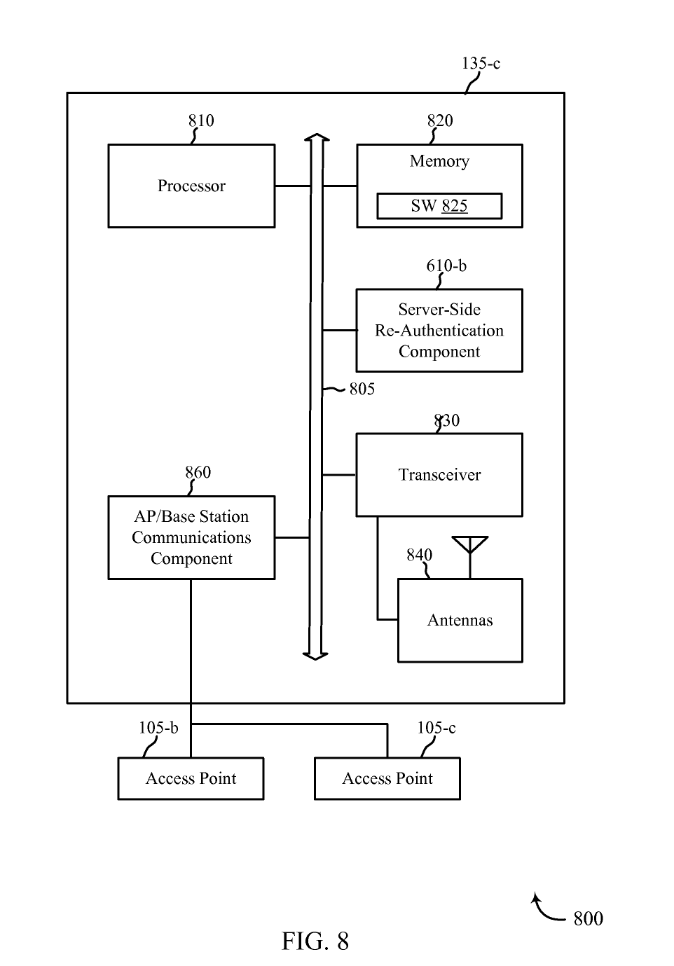

Turning to FIG. 8, a diagram 800 is shown that illustrates an authentication server 135-c capable of performing a re-authentication of a wireless station. The authentication server 135-c may be an example of the authentication servers 135 and/or apparatuses 135 of FIGS. 1, 6, and 7. The authentication server 135-c may include a processor 810, a memory 820, a transceiver 830, antennas 840, and a server-side re-authentication component 610-b. The server-side re-authentication component 610-b may be an example of the server-side re-authentication component 610 of FIG. 6 or 7. In some examples, the authentication server 135-c may also include an AP/base station communications component 860. Each of these components may be in communication with each other, directly or indirectly, over at least one bus 805.

The memory 820 may include RAM or ROM. The memory 820 may also store computer-readable, computer-executable SW code 825 containing instructions that, when executed, cause the processor 810 to perform various functions described herein for re-authenticating a wireless station with the authentication server 135-c. Alternatively, the software code 825 may not be directly executable by the processor 810 but cause the computer, (e.g., when compiled and executed) to perform functions described herein.

The processor 810 may include an intelligent hardware device, e.g., a CPU, a microcontroller, an ASIC, etc. The processor 810 may process information received through the transceiver 830 and/or the AP/base station communications component 860. The processor 810 may also process information to be sent to the transceiver 830 for transmission through the antennas 840 and/or the AP/base station communications component 860. The processor 810 may handle, alone or in connection with the server-side re-authentication component 610-b, various aspects related to re-authentication of a wireless station.

The transceiver 830 may include a modem to modulate the packets and provide the modulated packets to the antennas 840 for transmission, and to demodulate packets received from the antennas 840. The transceiver 830 may be implemented as at least one transmitter component and at least one separate receiver component. The transceiver 830 may communicate bi-directionally, via the antennas 840, with at least one access point 105, such as the access points 105 described with respect to FIG. 1. The authentication server 135-c may typically include multiple antennas 840 (e.g., an antenna array). The authentication server 135-c may communicate with APs/base stations, such as the access point/base station 105-b or the access point/base station 105-c, using the AP/base station communications component 860.

The components of the authentication server 135-c may implement aspects discussed above with respect FIGS. 1, 6, and 7, and those aspects may not be repeated here for the sake of brevity.

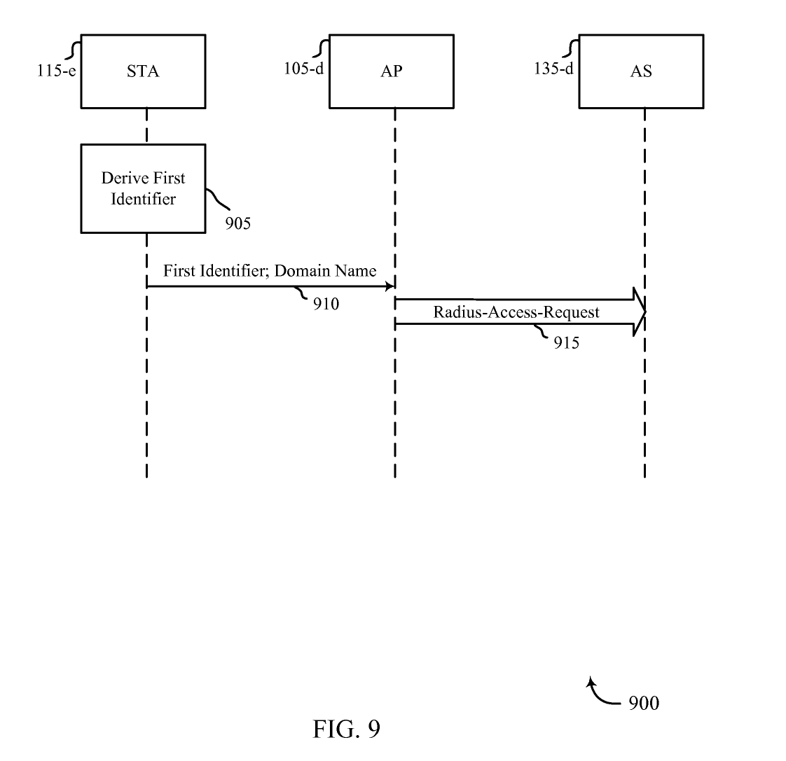

FIG. 9 is a swim lane diagram 900 illustrating aspects of wireless communication, in accordance with various aspects of the present disclosure. The diagram 900 may illustrate aspects of the WLAN network 100 described with reference to FIG. 1. The diagram 900 includes a wireless station (STA) 115-e, an access point (AP) 105-d, and an authentication server (AS) 135-d. The wireless station 115-e may be an example of at least one of the wireless stations 115 and/or the apparatuses 115 described above with respect to FIGS. 1 and 3-5. The access point 105-d may be an example of at least one of the access points 105 described above with respect to FIGS. 1, 5, and 8. The authentication server 135-d may be an example of at least one of the authentication severs 135 and/or the apparatuses 135 described above with respect to FIGS. 1 and 6-8. Generally, the diagram 900 illustrates aspects of re-authenticating the wireless station 115-e with the authentication server 135-d. In some examples, a system device, such as one of the wireless stations 115, apparatuses 115, access points 105, authentication servers 135, and/or apparatuses 135 may execute sets of codes to control the functional elements of the device to perform some or all of the functions described below.

At block 905, the wireless station 115-e may derive a first identifier at a wireless station from a re-authentication key and a sequence number. The re-authentication key may be derived at least in part from a first session key.

At 910, the wireless station 115-e may transmit to the access point 105-d (e.g., a type of authenticator) the first identifier and a domain name. The first identifier and the domain name may be transmitted during a first re-authentication of the wireless station 115-e with the authentication server 135-d. Transmission of a name of the first session key may be withheld during the first re-authentication. In some examples, the access point 105-d may use the domain name to identify the authentication server 135-d, and may transmit the first identifier to the authentication server 135-d as part of a Radius-Access-Request 915. In some examples, the first re-authentication may include a Wi-Fi re-authentication.

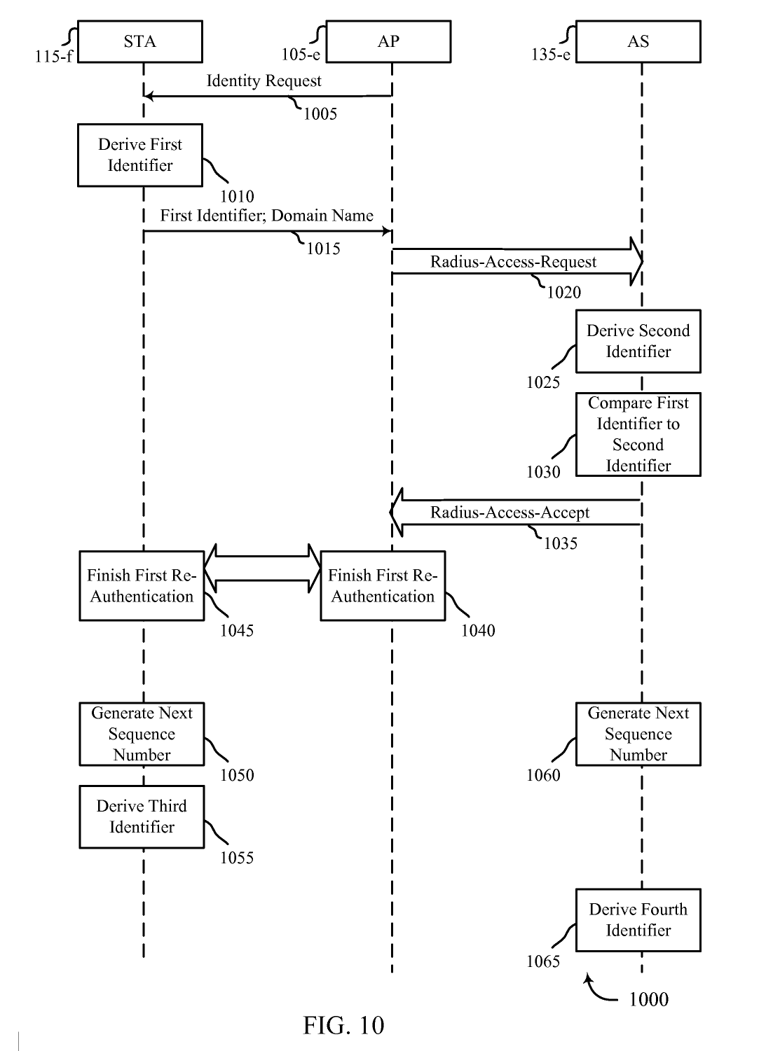

FIG. 10 is a swim lane diagram 1000 illustrating aspects of wireless communication, in accordance with various aspects of the present disclosure. The diagram 1000 may illustrate aspects of the WLAN network 100 described with reference to FIG. 1. The diagram 1000 includes a wireless station (STA) 115-f, an access point (AP) 105-e, and an authentication server (AS) 135-e. The wireless station 115-f may be an example of at least one of the wireless stations 115 and/or the apparatuses 115 described above with respect to FIGS. 1, 3-5, and 9. The access point 105-e may be an example of at least one of the access points 105 described above with respect to FIGS. 1, 5, 8, and 9. The authentication server 135-e may be an example of at least one of the authentication severs 135 and/or the apparatuses 135 described above with respect to FIGS. 1 and 6-9. Generally, the diagram 1000 illustrates aspects of re-authenticating the wireless station 115-f with the authentication server 135-e. In some examples, a system device, such as one of the wireless stations 115, apparatuses 115, access points 105, authentication servers 135, and/or apparatuses 135 may execute sets of codes to control the functional elements of the device to perform some or all of the functions described below.

At 1005, the access point 105-e may request the identity of the wireless station 115-f. In some examples, the access point 105-e may request the identity of the wireless station 115-f upon handover of the wireless station 115-f to the access point 105-e, or upon the wireless station 115-f attempting to access a network or services via the access point 105-e.

At block 1010, the wireless station 115-f may derive a first identifier at a wireless station from a first re-authentication key and a first sequence number. The first re-authentication key may be derived at least in part from a first session key.

At 1015, the wireless station 115-f may transmit to the access point 105-e (e.g., a type of authenticator), in response to the request for its identity, the first identifier and a domain name. The first identifier and the domain name may be transmitted during a first re-authentication of the wireless station 115-f with the authentication server 135-e. Transmission of a name of the first session key may be withheld during the first re-authentication. In some examples, the access point 105-e may use the domain name to identify the authentication server 135-e, and may transmit the first identifier to the authentication server 135-e, at 1020, as part of a Radius-Access-Request message.

At block 1025, the authentication server 135-e may derive a second identifier from a second re-authentication key and a second sequence number. The second re-authentication key may be derived at least in part from a second session key. If the wireless station 115-f previously completed a mutual full authentication with the authentication server 135-e, the first re-authentication key and the second re-authentication will be the same, the first session key and the second session key will be the same, and the first sequence number and the second sequence number will be the same.

At block 1030, the authentication server 135-e may compare the first identifier to the second identifier and determine the first identifier matches the second identifier.

At 1035, the authentication server 135-e may transmit to the access point 105-e a third session key. In some examples, the authentication server 135-e may transmit the third session key to the access point 105-e as part of a Radius-Access-Accept message.

At blocks 1040 and 1045, and based at least in part on the access point's receipt of the third session key, the access point 105-e and the wireless station 115-f may finish the first re-authentication.

At block 1050, the wireless station 115-f may generate a next sequence number (e.g., a third sequence number) based at least in part on the first sequence number. At block 1055, the wireless station 115-f may derive a third identifier based at least in part on the first re-authentication key and the third sequence number. The third identifier and the domain name may be transmitted to the authentication server 135-e during a second re-authentication of the wireless station 115-f with the authentication server 135-e. In some examples, the second re-authentication may be performed via an access point other than the access point 105-e. Transmission of a name of the first session key may also be withheld during the second re-authentication.

At block 1060, the authentication server 135-e may generate a next sequence number (e.g., a fourth sequence number) based at least in part on the second sequence number. At block 1065, the authentication server 135-e may derive a fourth identifier based at least in part on the second re-authentication key and the fourth sequence number. If a second re-authentication is initiated, the authentication server 135-e may receive the third identifier from the wireless station 115-f and compare the third identifier to the fourth identifier.

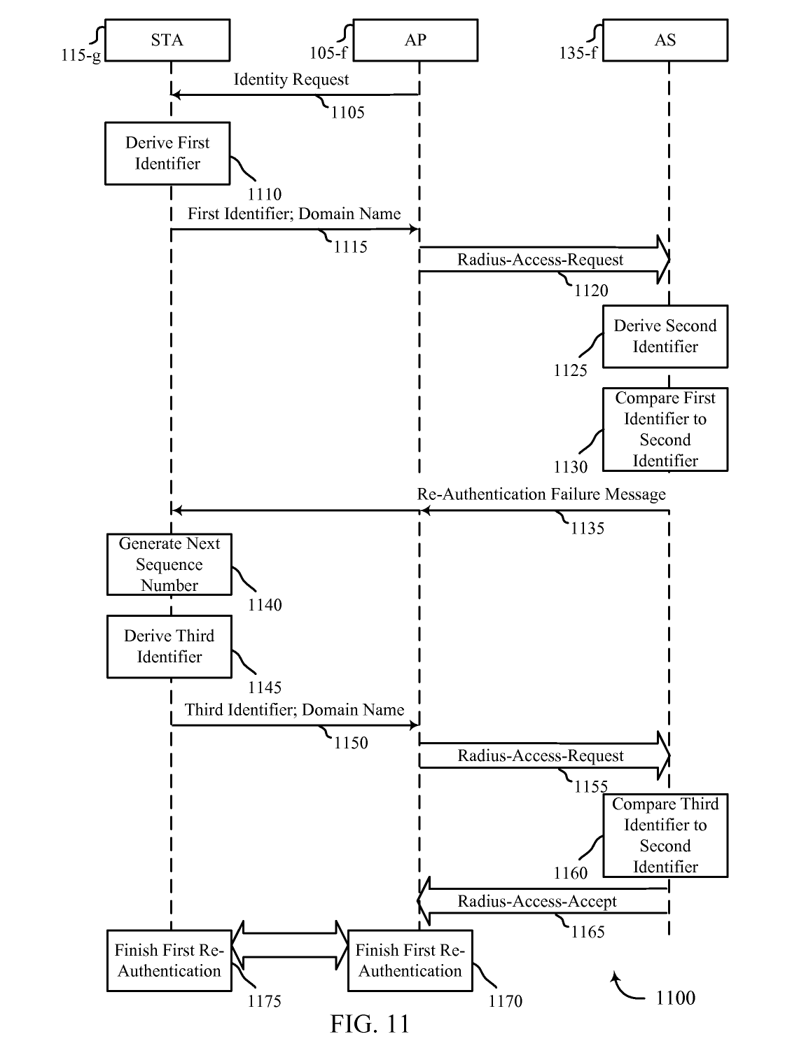

FIG. 11 is a swim lane diagram 1100 illustrating aspects of wireless communication, in accordance with various aspects of the present disclosure. The diagram 1100 may illustrate aspects of the WLAN network 100 described with reference to FIG. 1. The diagram 1100 includes a wireless station (STA) 115-g, an access point (AP) 105-f, and an authentication server (AS) 135-f The wireless station 115-g may be an example of at least one of the wireless stations 115 and/or the apparatuses 115 described above with respect to FIGS. 1, 3-5, 9, and 10. The access point 105-f may be an example of at least one of the access points 105 described above with respect to FIGS. 1, 5, and 8-10. The authentication server 135-f may be an example of at least one of the authentication severs 135 and/or the apparatuses 135 described above with respect to FIGS. 1 and 6-10. Generally, the diagram 1100 illustrates aspects of re-authenticating the wireless station 115-g with the authentication server 135-f. In some examples, a system device, such as one of the wireless stations 115, apparatuses 115, access points 105, authentication servers 135, and/or apparatuses 135 may execute sets of codes to control the functional elements of the device to perform some or all of the functions described below.

At 1105, the access point 105-f may request the identity of the wireless station 115-g. In some examples, the access point 105-f may request the identity of the wireless station 115-f upon handover of the wireless station 115-g to the access point 105-f, or upon the wireless station 115-g attempting to access a network or services via the access point 105-f.

At block 1110, the wireless station 115-g may derive a first identifier at a wireless station from a first re-authentication key and a first sequence number. The first re-authentication key may be derived at least in part from a first session key.

At 1115, the wireless station 115-g may transmit to the access point 105-f (e.g., a type of authenticator), in response to the request for its identity, the first identifier and a domain name. The first identifier and the domain name may be transmitted during a first re-authentication of the wireless station 115-g with the authentication server 135-f Transmission of a name of the first session key may be withheld during the first re-authentication. In some examples, the access point 105-f may use the domain name to identify the authentication server 135-e, and may transmit the first identifier to the authentication server 135-f, at 1120, as part of a Radius-Access-Request message.

At block 1125, the authentication server 135-f may derive a second identifier from a second re-authentication key and a second sequence number. The second re-authentication key may be derived at least in part from a second session key. If the wireless station 115-g previously completed a mutual full authentication with the authentication server 135-f, the first re-authentication key and the second re-authentication will be the same, the first session key and the second session key will be the same, and the first sequence number and the second sequence number will be the same.

At block 1130, the authentication server 135-f may compare the first identifier to the second identifier and determine the first identifier does not match the second identifier.

At 1135, the authentication server 135-f may transmit to the wireless station 115-g, via the access point 105-f, a re-authentication failure message. The re-authentication failure message may include a TLV element indicating a mismatch between the first identifier and the second identifier. Because the authentication server 135-f cannot match identifiers, the transmission of the re-authentication failure message may not be integrity protected (e.g., the authentication server 135-f may be unable to locate an rIK corresponding to an rRK).

At block 1140, the wireless station 115-g may generate a next sequence number (e.g., a third sequence number) based at least in part on the first sequence number. At block 1145, the wireless station 115-g may derive a third identifier based at least in part on the first re-authentication key and the third sequence number. At 1150, the wireless station 115-g may transmit the third identifier and the domain name to the access point 105-f, in a second attempt to perform the first re-authentication. In some examples, the access point 105-f may transmit the third identifier to the authentication server 135-f, at 1155, as part of a second Radius-Access-Request message. Alternatively (e.g., alternatively to 1140, 1145, 1150, and 1155), the wireless station 115-g may indicate a failure to re-authenticate and/or trigger a mutual full authentication of the wireless station 115-g with the authentication server 135-f.

At block 1160, the authentication server 135-f may compare the third identifier to the second identifier. When the third identifier matches the second identifier, the authentication server 135-f may transmit a third session key to the access point 105-f at 1165. In some examples, the authentication server 135-f may transmit the third session key to the access point 105-f as part of a Radius-Access-Accept message.

At blocks 1170 and 1175, and based at least in part on the access point's receipt of the third session key, the access point 105-f and the wireless station 115-g may finish the first re-authentication.

When the third identifier does not match the second identifier, the authentication server 135-f may transmit a second re-authentication failure message to the wireless station 115-g via the access point 105-f The second re-authentication failure message may trigger another attempt to perform the first re-authentication or trigger the initiation of a full authentication of the wireless station 115-g with the authentication server 135-f.

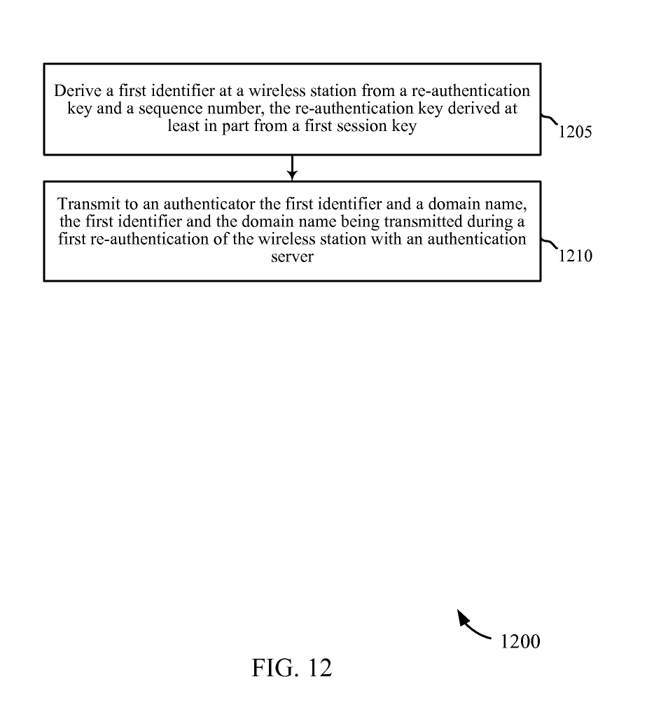

FIG. 12 is a flow chart illustrating an example of a method 1200 for wireless communication, in accordance with various aspects of the present disclosure. For clarity, the method 1200 is described below with reference to aspects of the wireless stations described with reference to FIGS. 1, 5, and 9-11, or aspects of the apparatuses described with reference to FIGS. 3 and 4. In some examples, a wireless station may execute sets of codes to control the functional elements of the wireless station to perform the functions described below. Additionally or alternatively, the wireless station may perform the functions described below using special-purpose hardware.

At block 1205, the method 1200 may include deriving a first identifier at a wireless station from a re-authentication key and a sequence number. The re-authentication key may be derived at least in part from a first session key. At block 1210, the method 1200 may include transmitting to an authenticator (e.g., an access point) the first identifier and a domain name. The first identifier and the domain name may be transmitted during a first re-authentication of the wireless station with an authentication server. Transmission of a name of the first session key may be withheld during the first re-authentication. In some examples, the method 1200 may include using the first identifier for a single re-authentication of the wireless station with the authentication server. In some examples, the first re-authentication may include a Wi-Fi re-authentication.

The operation(s) at blocks 1205 and 1210 may be performed using the station-side re-authentication component 310 described with reference to FIGS. 3-5.

Thus, the method 1200 may provide for wireless communication. It should be noted that the method 1200 is just one implementation and that the operations of the method 1200 may be rearranged or otherwise modified such that other implementations are possible.

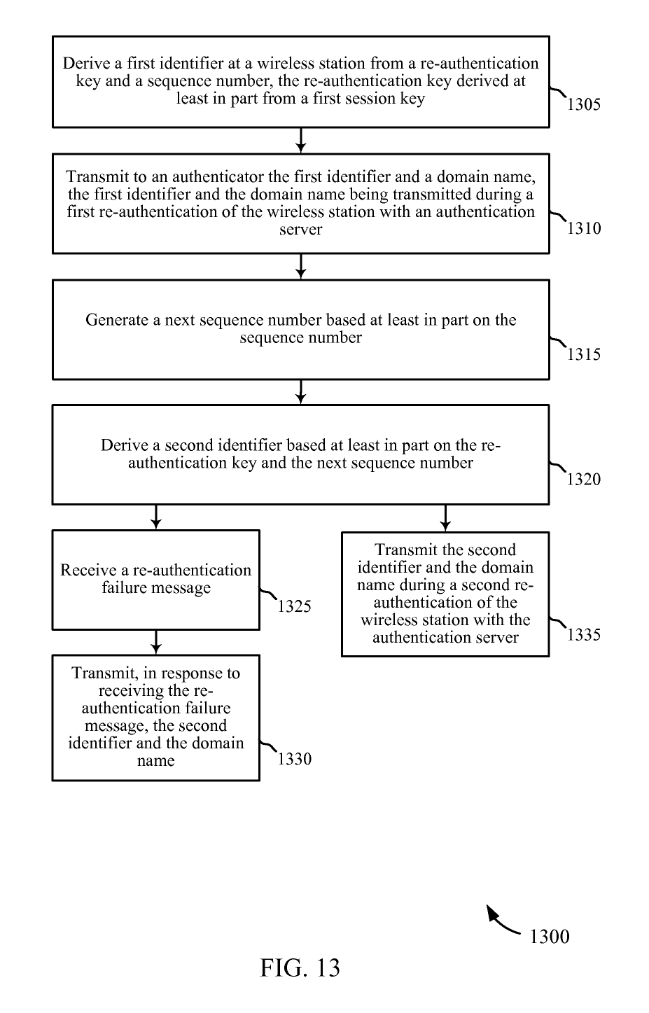

FIG. 13 is a flow chart illustrating an example of a method 1300 for wireless communication, in accordance with various aspects of the present disclosure. For clarity, the method 1200 is described below with reference to aspects of the wireless stations described with reference to FIGS. 1, 5, and 9-11, or aspects of the apparatuses described with reference to FIGS. 3 and 4. In some examples, a wireless station may execute sets of codes to control the functional elements of the wireless station to perform the functions described below. Additionally or alternatively, the wireless station may perform the functions described below using special-purpose hardware.

At block 1305, the method 1300 may include deriving a first identifier at a wireless station from a re-authentication key and a sequence number. The re-authentication key may be derived at least in part from a first session key. At block 1310, the method 1300 may include transmitting to an authenticator (e.g., an access point) the first identifier and a domain name. The first identifier and the domain name may be transmitted during a first re-authentication of the wireless station with an authentication server. Transmission of a name of the first session key may be withheld during the first re-authentication. In some examples, the method 1300 may include using the first identifier for a single re-authentication of the wireless station with the authentication server. In some examples, the first re-authentication may include a Wi-Fi re-authentication.

At block 1315, the method 1300 may include generating a next sequence number based at least in part on the sequence number. At block 1320, the method 1300 may include deriving a second identifier based at least in part on the re-authentication key and the next sequence number.

At block 1325, and in a first optional flow, the method 1300 may include receiving a re-authentication failure message. The re-authentication failure message may be received upon failure of the first re-authentication. At block 1330, the method 1300 may include transmitting, in response to receiving the re-authentication failure message, the second identifier and the domain name. In some examples, the next sequence number generated at block 1315 or the second identifier derived at block 1320 may be generated/derived after receiving the re-authentication failure message at block 1325.

At block 1335, and in a second optional flow, the method 1300 may include transmitting the second identifier and the domain name during a second re-authentication of the wireless station with the authentication server. In some examples, the first re-authentication may involve transmitting the first identifier and the domain name to the authentication server via a first authenticator (e.g., a first access point), and the second re-authentication may involve transmitting the second identifier and the domain name to the authentication server via a second authenticator (e.g., a second access point).

Transmission of a name of the first session key may be withheld when responding to the re-authentication failure message, at block 1330, or during the second re-authentication, at block 1335. In some examples, the method 1300 may include using each of the first identifier and the second identifier for a single attempt to re-authenticate the wireless station with the authentication server.

The operation(s) at blocks 1305, 1310, 1315, 1320, 1325, 1330, and 1335 may be performed using the station-side re-authentication component 310 described with reference to FIGS. 3-5.

Thus, the method 1300 may provide for wireless communication. It should be noted that the method 1300 is just one implementation and that the operations of the method 1300 may be rearranged or otherwise modified such that other implementations are possible.

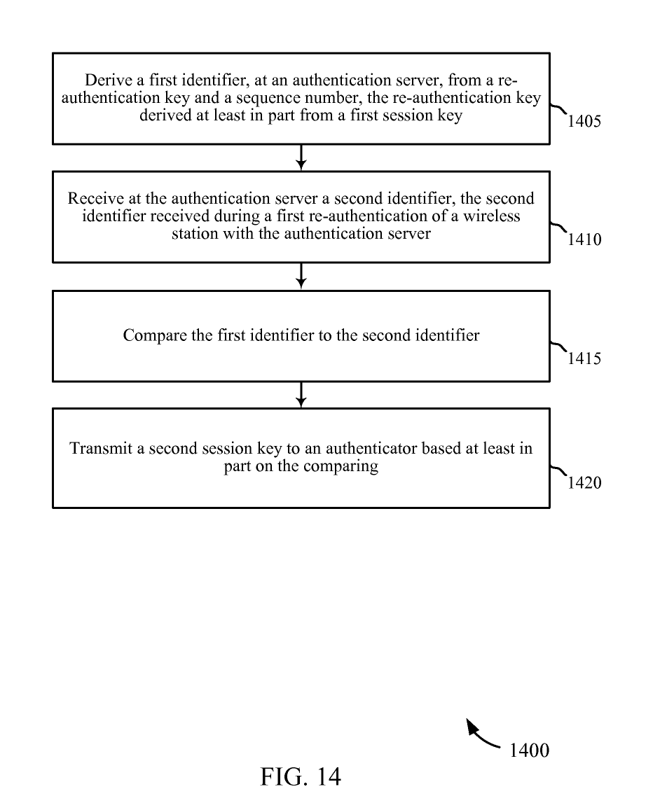

FIG. 14 is a flow chart illustrating an example of a method 1400 for wireless communication, in accordance with various aspects of the present disclosure. For clarity, the method 1400 is described below with reference to aspects of the authentication servers described with reference to FIGS. 1 and 8-11, or aspects of the apparatuses described with reference to FIGS. 5 and 6. In some examples, an authentication server may execute sets of codes to control the functional elements of the authentication server to perform the functions described below. Additionally or alternatively, the authentication server may perform the functions described below using special-purpose hardware.

At block 1405, the method 1400 may include deriving a first identifier, at an authentication server, from a re-authentication key and a sequence number. The re-authentication key may be derived at least in part from a first session key. At block 1410, the method 1400 may include receiving at the authentication server a second identifier. The second identifier may be received during a first re-authentication of a wireless station with the authentication server. At block 1415, the method 1400 may include comparing the first identifier to the second identifier. At block 1420, the method 1400 may include transmitting a second session key based at least in part on the comparing. For example, when the first identifier matches the second identifier, the second session key may be transmitted to an authenticator (e.g., an access point) via which the second identifier is received. In some examples, the re-authentication may include a Wi-Fi re-authentication.

The operation(s) at blocks 1405, 1410, 1415, and 1420 may be performed using the server-side re-authentication component 610 described with reference to FIGS. 6-8.

Thus, the method 1400 may provide for wireless communication. It should be noted that the method 1400 is just one implementation and that the operations of the method 1400 may be rearranged or otherwise modified such that other implementations are possible.

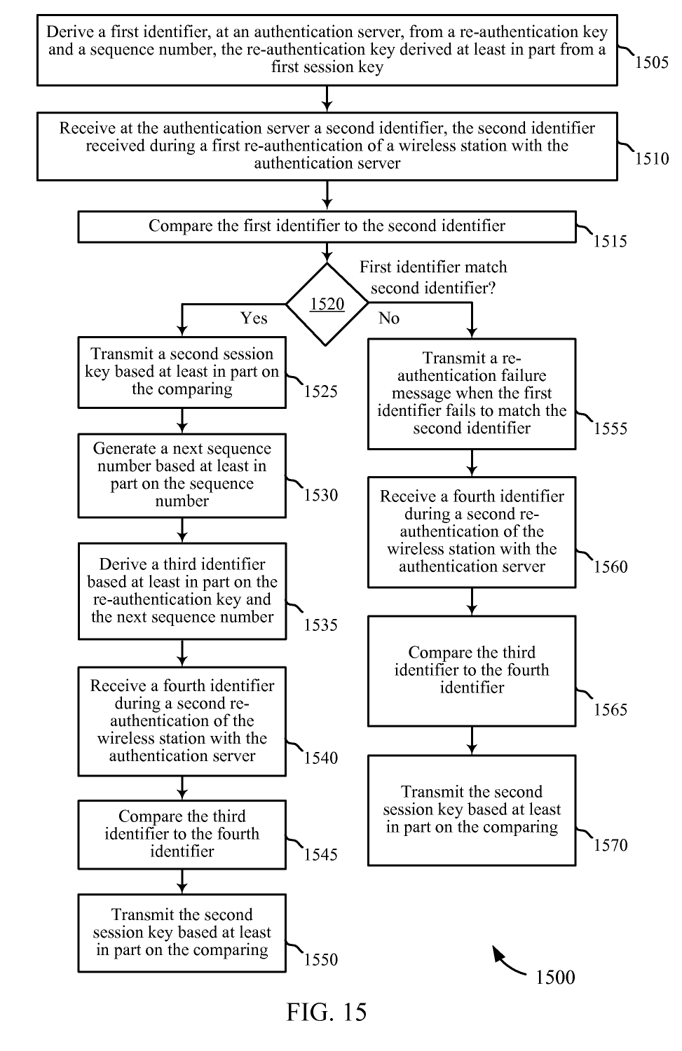

FIG. 15 is a flow chart illustrating an example of a method 1500 for wireless communication, in accordance with various aspects of the present disclosure. For clarity, the method 1500 is described below with reference to aspects of the authentication servers described with reference to FIGS. 1 and 8-11, or aspects of the apparatuses described with reference to FIGS. 6 and 7. In some examples, an authentication server may execute sets of codes to control the functional elements of the authentication server to perform the functions described below. Additionally or alternatively, the authentication server may perform the functions described below using special-purpose hardware.

At block 1505, the method 1500 may include deriving a first identifier, at an authentication server, from a re-authentication key and a sequence number. The re-authentication key may be derived at least in part from a first session key. At block 1510, the method 1500 may include receiving at the authentication server a second identifier. The second identifier may be received during a first re-authentication of a wireless station with the authentication server. At block 1515, the method 1500 may include comparing the first identifier to the second identifier. In some examples, the re-authentication may include a Wi-Fi re-authentication.

At block 1520, the method 1500 may include determining whether the first identifier matches the second identifier. When the first identifier matches the second identifier, the method 1500 may continue at block 1525. When the first identifier does not match the second identifier, the method 1500 may continue at block 1555.

At block 1525, the method 1500 may include transmitting a second session key based at least in part on the comparing. The second session key may be transmitted to an authenticator (e.g., an access point) via which the second identifier is received from the wireless station.

At block 1530, the method 1500 may include generating a next sequence number based at least in part on the sequence number. At block 1535, the method 1500 may include deriving a third identifier based at least in part on the re-authentication key and the next sequence number.

At block 1540, the method 1500 may include receiving a fourth identifier during a second re-authentication of the wireless station with the authentication server. At block 1545, the method 1500 may include comparing the third identifier to the fourth identifier. At block 1550, the method 1500 may include transmitting the second session key based at least in part on the comparing. For example, when the third identifier matches the fourth identifier, the second session key may be transmitted to an authenticator (e.g., an access point) via which the fourth identifier is received from the wireless station. In some examples, the first re-authentication may involve receiving the second identifier from the wireless station via a first access point, and the second re-authentication may involve receiving the fourth identifier from the wireless station via a second access point.

At block 1555, the method 1500 may include transmitting a re-authentication failure message when the first identifier fails to match the second identifier. The re-authentication failure message may include a TLV element indicating a mismatch between the first identifier and the second identifier. At block 1560, the method 1500 may include receiving a fourth identifier during a second attempt by the wireless station to perform the first re-authentication. At block 1565, the method 1500 may include comparing the third identifier to the fourth identifier. At block 1570, the method 1500 may include transmitting the second session key based at least in part on the comparing. For example, when the third identifier matches the fourth identifier, the second session key may be transmitted to an authenticator (e.g., an access point) via which the fourth identifier is received from the wireless station.

The operation(s) at blocks 1505, 1510, 1515, 1520, 1525, 1530, 1535, 1540, 1545, 1550, 1555, 1560, 1565, and 1570 may be performed using the server-side re-authentication component 610 described with reference to FIGS. 6-8.

Thus, the method 1500 may provide for wireless communication. It should be noted that the method 1500 is just one implementation and that the operations of the method 1500 may be rearranged or otherwise modified such that other implementations are possible.

In some examples, aspects from the methods 1200 and 1300 may be combined, or aspects from the methods 1400 and 1500 may be combined. It should be noted that the methods 1200, 1300, etc. are just example implementations, and that the operations of the methods 1200-1500 may be rearranged or otherwise modified such that other implementations are possible.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Throughout this disclosure the term “example” or “exemplary” indicates an example or instance and does not imply or require any preference for the noted example. Thus, the disclosure is not to be limited to the examples and designs described herein but is to be accorded the broadest scope consistent with the principles and novel features disclosed herein.

What is claimed is:

1. A method for wireless communication, comprising:
deriving a first identifier at a wireless station from a re-authentication key and a sequence number, the re-authentication key derived at least in part from a first session key;
transmitting to an authenticator the first identifier and a domain name, the first identifier and the domain name being transmitted during a first re-authentication of the wireless station with an authentication server; and
withholding transmission of a name of the first session key during the first re-authentication.

2. The method of claim 1, further comprising:
generating a next sequence number based at least in part on the sequence number; and
deriving a second identifier based at least in part on the re-authentication key and the next sequence number.

3. The method of claim 2, further comprising:
transmitting the second identifier and the domain name, the second identifier and the domain name being transmitted during a second re-authentication of the wireless station with the authentication server.

4. The method of claim 2, further comprising:
receiving a re-authentication failure message; and
transmitting, in response to receiving the re-authentication failure message, the second identifier and the domain name.

5. The method of claim 1, further comprising:
using the first identifier for a single re-authentication of the wireless station with the authentication server.

6. The method of claim 1, further comprising:
deriving the first identifier based at least in part on an identifier label.

7. The method of claim 1, wherein the first re-authentication comprises an extensible authentication protocol (EAP) re-authentication, the first session key comprises an extended master session key (EMSK), and the re-authentication key comprises a re-authentication root key (rRK).

8. The method of claim 1, wherein the first re-authentication is performed after performing a full authentication with the authentication server.

9. The method of claim 1, further comprising:
receiving a re-authentication failure message; and
performing a full authentication with the authentication server in response to receiving the re-authentication failure message.

10. An apparatus for wireless communication, comprising:
a processor;
memory in electronic communication with the processor; and
instructions being stored in the memory, the instructions being executable by the processor to:
derive a first identifier at a wireless station from a re-authentication key and a sequence number, the re-authentication key derived at least in part from a first session key;
transmit to an authenticator the first identifier and a domain name, the first identifier and the domain name being transmitted during a first re-authentication of the wireless station with an authentication server; and
withhold transmission of a name of the first session key during the first re-authentication.

11. The apparatus of claim 10, further comprising instructions executable by the processor to:
generate a next sequence number based at least in part on the sequence number; and
derive a second identifier based at least in part on the re-authentication key and the next sequence number.

12. The apparatus of claim 11, further comprising instructions executable by the processor to:
transmit the second identifier and the domain name, the second identifier and the domain name being transmitted during a second re-authentication of the wireless station with the authentication server.

13. The apparatus of claim 11, further comprising instructions executable by the processor to:
receive a re-authentication failure message; and
transmit, in response to receiving the re-authentication failure message, the second identifier and the domain name.

14. The apparatus of claim 10, further comprising instructions executable by the processor to:
use the first identifier for a single re-authentication of the wireless station with the authentication server.

15. The apparatus of claim 10, further comprising instructions executable by the processor to:
derive the first identifier based at least in part on an identifier label.

16. The apparatus of claim 10, wherein the first re-authentication comprises an extensible authentication protocol (EAP) re-authentication, the first session key comprises an extended master session key (EMSK), and the re-authentication key comprises a re-authentication root key (rRK).

17. The apparatus of claim 10, wherein the first re-authentication is performed after performing a full authentication with the authentication server.

18. The apparatus of claim 10, further comprising instructions executable by the processor to:
receive a re-authentication failure message; and
perform a full authentication with the authentication server in response to receiving the re-authentication failure message.

19. A method for wireless communication, comprising:
deriving a first identifier, at an authentication server, from a re-authentication key and a sequence number, the re-authentication key derived at least in part from a first session key;
receiving at the authentication server a second identifier, the second identifier received during a first re-authentication of a wireless station with the authentication server;
comparing the first identifier to the second identifier; and
transmitting a second session key to an authenticator of the wireless station based at least in part on the comparing.

20. The method of claim 19, wherein the first identifier matches the second identifier.

21. The method of claim 19, further comprising:
generating a next sequence number based at least in part on the sequence number; and
deriving a third identifier based at least in part on the re-authentication key and the next sequence number.

22. The method of claim 21, further comprising:
receiving a fourth identifier during a second re-authentication of the wireless station with the authentication server;
comparing the third identifier to the fourth identifier; and
transmitting the second session key based at least in part on the comparing.

23. The method of claim 22, wherein the third identifier matches the fourth identifier.

24. The method of claim 19, further comprising:
deriving the first identifier based at least in part on an identifier label.

25. The method of claim 19, further comprising:
transmitting a re-authentication failure message when the first identifier fails to match the second identifier.

26. The method of claim 25, wherein the re-authentication failure message comprises a type-length value (TLV) element indicating a mismatch between the first identifier and the second identifier.

27. The method of claim 19, wherein the first re-authentication comprises an extensible authentication protocol (EAP) re-authentication, the first session key comprises an extended master session key (EMSK), the re-authentication key comprises a re-authentication root key (rRK), and the second session key comprises a re-authentication master session key (rMSK).

28. An apparatus for wireless communication, comprising:
a processor;
memory in electronic communication with the processor; and
instructions being stored in the memory, the instructions being executable by the processor to:
derive a first identifier, at an authentication server, from a re-authentication key and a sequence number, the re-authentication key derived at least in part from a first session key;
receive at the authentication server a second identifier, the second identifier received during a first re-authentication of a wireless station with the authentication server;
compare the first identifier to the second identifier; and
transmit a second session key to an authenticator of the wireless station based at least in part on the comparing.

29. The apparatus of claim 28, wherein the first identifier matches the second identifier.

30. The apparatus of claim 28, further comprising instructions executable by the processor to:
generate a next sequence number based at least in part on the sequence number; and
derive a third identifier based at least in part on the re-authentication key and the next sequence number.
